(19) United States
(12) Patent Application Publication
(10) Pub. No.: US 2016/0275851 A1
(43) Pub. Date: Sep. 22, 2016

(54) SEMICONDUCTOR DEVICE

(71) Applicant: SAMSUNG ELECTRONICS CO., LTD., SUWON-SI (KR)

(72) Inventors: Sung-Hoo Choi, Hwaseong-si (KR); Jong-Ho Roh, Yongin-si (KR); Dong-Han Lee, Seongnam-si (KR); Jong-Hyup Lee, Seoul (KR)

(21) Appl. No.: 15/065,919

(22) Filed: Mar. 10, 2016

(30) Foreign Application Priority Data
Mar. 17, 2015 (KR) 10-2015-0036436

(51) Int. Cl. G09G 3/20

(52) U.S. Cl. CPC G09G 3/2092; G09G 2310/06

(57) ABSTRACT

A semiconductor device includes a controller that monitors a first toggle rate of first data and determines a conversion mode for the first data, and a first toggle rate converter that converts the first data into second data having a second toggle rate different from the first toggle rate when the conversion mode is a first mode, and that converts the first data into third data having a third toggle rate different from the first and second toggle rates when the conversion mode is a second mode different from the first mode.

### CROSS-REFERENCE TO RELATED APPLICATION

A claim for priority under 35 U.S.C. §119 is made to Korean Patent Application No. 10-2015-0036436 filed on Mar. 17, 2015 in the Korean Intellectual Property Office, the entire contents of which are hereby incorporated herein by reference.

### BACKGROUND

The present inventive concepts described herein relate to a semiconductor device.

In view of improvements made in the performance of electronic devices, the degree of resolution of display panels mounted in electronic devices has gradually increased. However, as the resolution of such displays has increased, the amount of power required by driving systems to drive such high resolution panels has correspondingly increased significantly.

### SUMMARY

Embodiments of the present concept may provide a semiconductor device enables reduction of operating power consumption.

Embodiments of the present inventive concept provide a semiconductor device including a controller configured to monitor a first toggle rate of first data and determine a conversion mode for the first data. The semiconductor device further includes a first toggle rate converter configured to convert the first data into second data having a second toggle rate different from the first toggle rate when the conversion mode is a first mode, and convert the first data into third data having a third toggle rate different from the first and second toggle rates when the conversion mode is a second mode different from the first mode.

In some embodiments of the inventive concept, the first toggle rate converter is further configured to pass the first data without conversion of the first toggle rate when the conversion mode is a third mode different from the first mode and the second mode.

In some embodiments of the inventive concept, the second data is responsive to an XOR or XNOR operation between the first data and first comparative data.

In some embodiments of the inventive concept, the third data is responsive to an XOR or XNOR operation between the first data and second comparative data different from the first comparative data.

In some embodiments of the inventive concept, the controller includes a monitor configured to monitor the first toggle rate, a comparator configured to compare the first toggle rate and a reference value and determine whether or not the first toggle rate is identical to or higher than the reference value, and a mode selector configured to select the conversion mode according to a result of comparator.

In some embodiments of the present inventive concept, the semiconductor device is further configured to monitor fourth data having a fourth toggle rate and determine a conversion mode for the fourth data. The semiconductor device further includes a second toggle rate converter configured to convert the fourth data into fifth data having a fifth toggle rate different from the fourth toggle rate when the conversion mode is a third mode, and to pass the fourth data without conversion of the fourth toggle rate when the conversion mode is a fourth mode.

In some embodiments of the inventive concept, the semiconductor device further includes a memory configured to store the first toggle rate therein. The controller is further configured to receive the first toggle rate stored in the memory and determine the conversion mode for the first data.

Embodiments of the inventive concept provide a semiconductor device including a controller configured to receive a bit stream, parse the bit stream into first data and second data respectively having a predetermined bit length, output a first control signal when a first toggle rate of the first data is equal to or higher than a reference value and output a second control signal when a second toggle rate of the second data is equal to or higher than the reference value. The semiconductor device further includes a first toggle rate converter configured to receive the bit stream, convert the first data into third data having a third toggle rate when the first control signal is applied thereto, and convert the second data into fourth data having a fourth toggle rate when the second control signal is applied thereto.

In some embodiments of the inventive concept, the first toggle rate and the third toggle rate are different from each other, and the second toggle rate and the fourth toggle rate are identical to each other.

In some embodiments of the inventive concept, the first toggle rate and the third toggle rate are different from each other, and the second toggle rate and the fourth toggle rate are different from each other.

In some embodiment of the inventive concept, the semiconductor device further includes a second toggle rate converter and a processing unit, wherein the bit stream includes a bit stream of image data. The second toggle rate converter is configured to receive one of the third data and the fourth data from the first toggle rate converter and convert the one of the third data and the fourth data into the first data. The processing unit is configured to perform image processing using the first data.

Embodiments of the inventive concept provide a semiconductor device including a generator configured to generate first data having a first toggle rate, a controller configured to monitor the first toggle rate and determine a conversion mode for the first data, and a modulator configured to convert the first data into second data having a second toggle rate when the conversion mode is a first mode, and convert the first data into third data having a third toggle rate when the conversion mode is a second mode different from the first mode. The semiconductor device further includes a demodulator configured to receive one of the second data and the third data and convert the one of the second data and the third data into the first data according to the conversion mode, and a processing unit configured to perform processing using the first data.

In some embodiments of the inventive concept, the generator includes a multimedia system configured to generate image data, and the processing unit includes a central processing unit (CPU) configured to perform processing on the image data.

In some embodiments of the inventive concept, the first toggle rate and the third toggle rate are different from each other, and the second toggle rate and the fourth toggle rate are identical to each other.

In some embodiments of the inventive concept, the controller includes a first controller and a second controller, and the first controller is disposed within the generator and the second controller is disposed within the processing unit.

However, embodiments of the inventive concept are not restricted to the ones set forth herein. The above and other embodiments of the inventive concept will become more apparent to one of ordinary skill in the art to which the inventive concept pertains by referencing the detailed description given below.

### BRIEF DESCRIPTION OF DRAWINGS

The above and other aspects and features of the present inventive concept will become more apparent from the following description taken in conjunction with the accompanying drawings, in which:

FIG. 1 illustrates a block diagram of a semiconductor device according to an embodiment of the inventive concept.

FIG. 1A illustrates a block diagram of a configuration and the operation of a controller of FIG. 1.

FIG. 2 illustrates a block diagram of a semiconductor device according to another embodiment of the inventive concept.

FIG. 3 illustrates a block diagram of a semiconductor device according to another embodiment of the inventive concept.

FIG. 4 illustrates a block diagram of a memory and a controller in a semiconductor device according to an embodiment of the inventive concept.

FIG. 5 illustrates a block diagram of a semiconductor device according to another embodiment of the inventive concept.

FIG. 6 illustrates a block diagram of a semiconductor device according to another embodiment of the inventive concept.

FIG. 7 illustrates a block diagram of a semiconductor device according to another embodiment of the inventive concept.

FIG. 8 illustrates a block diagram of a semiconductor device according to another embodiment of the inventive concept.

FIG. 9 illustrates a block diagram of a semiconductor device according to another embodiment of the inventive concept.

FIG. 10 illustrates a block diagram of a semiconductor device according to another embodiment of the inventive concept.

FIG. 11 illustrates a block diagram of a semiconductor device according to another embodiment of the inventive concept.

FIG. 12 illustrates a tablet personal computer (PC) which may incorporate semiconductor devices according to embodiments of the inventive concept.

FIG. 13 illustrates a laptop computer which may incorporate semiconductor devices according to embodiments of the inventive concept.

FIG. 14 illustrates a smartphone which may incorporate semiconductor devices according to embodiments of the inventive concept.

### DETAILED DESCRIPTION

Embodiments of the inventive concept will be described more fully hereinafter with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art. The same reference numbers indicate the same components throughout the specification. In the attached figures, the thickness of layers and regions may be exaggerated for clarity.

It should be understood that when an element or layer is referred to as being “connected to,” or “coupled to” another element or layer, it may be directly connected to or coupled to the another element or layer, or intervening elements or layers may be present. In contrast, when an element is referred to as being “directly connected to” or “directly coupled to” another element or layer, there are no intervening elements or layers present. Like numbers refer to like elements throughout. As used herein, the term “and/or” includes any and all combinations of one or more of the associated listed items.

It should also be understood that when a layer is referred to as being “on” another layer or substrate, it may be directly on the another layer or substrate, or intervening layers may also be present. In contrast, when an element is referred to as being “directly on” another element, there are no intervening elements or layers present.

It should be understood that, although the terms first, second, etc. may be used herein to describe various elements, such elements should not be limited by these terms. These terms are only used to distinguish one element from another element. Thus, for example, a first element, a first component or a first section discussed below may be termed a second element, a second component or a second section without departing from the teachings of the inventive concept.

The use of the terms “a” and “an” and “the” and similar referents in the context of describing the inventive concept (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Unless defined otherwise, all technical and scientific terms used herein have the same meaning as commonly understood by one of ordinary skill in the art to which this inventive concept belongs. It is noted that the use of any and all examples, or exemplary terms provided herein, is intended merely to better illuminate the inventive concept and should not limit the scope of the inventive concept unless otherwise specified. Further, unless defined otherwise, terms such as those defined in commonly used dictionaries should be interpreted as having a meaning that is consistent with their meaning in the context of the relevant art and/or the present application, and should not be interpreted in an idealized or overly formal sense unless expressly so defined herein.

Hereinafter, the inventive concept will be described in detail with reference to the accompanying drawings which show examples of the inventive concept and which thus should not be construed as limiting.

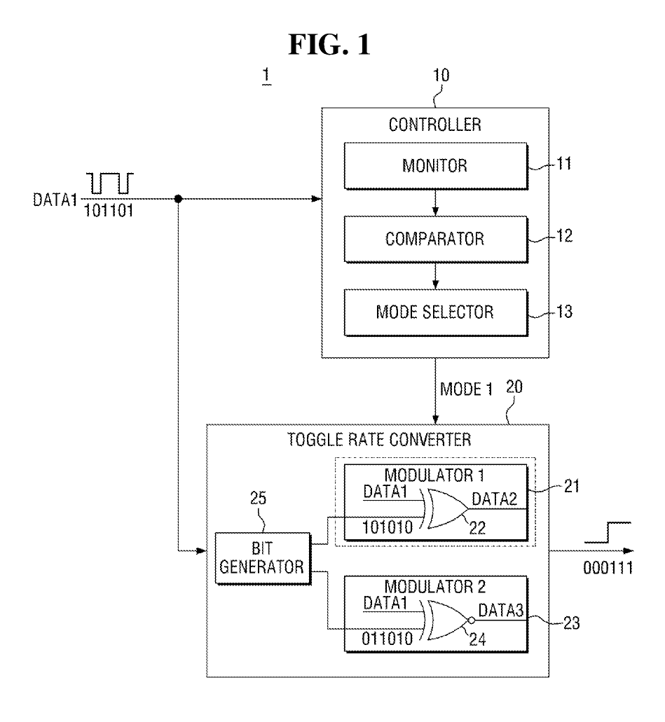

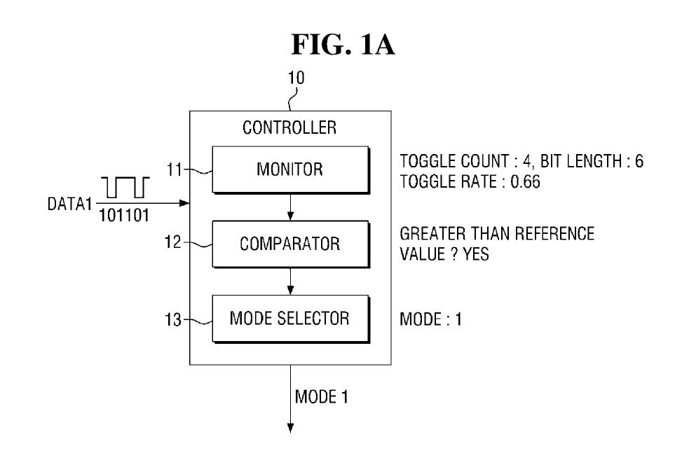

FIG. 1 illustrates a block diagram of a semiconductor device according to an embodiment of the inventive concept.

Referring to FIG. 1, semiconductor device 1 includes a controller 10 and a toggle rate converter 20. Controller 10 as shown includes a monitor 11 that monitors a toggle rate of first data DATA1 provided thereto, a comparator 12 that compares the toggle rate of the first data DATA1 monitored by the monitor 11 with a predetermined reference value, and a mode selector 13 that sets a conversion mode according to a result of the comparison between the toggle rate of the first data DATA1 and the predetermined reference value.

The controller 10 may determine the conversion mode depending on the toggle rate of first data DATA1 provided thereto. The conversion mode determined as described above is transmitted to the toggle rate converter 20. Operations of the controller 10 will be described in detail subsequently.

The toggle rate converter 20 includes a first modulator (Modulator 1) 21 and a second modulator (Modulator 2) 23, and a bit generator 25.

The first modulator 21 includes a first logic device 22 that performs a logic operation between the first data DATA1 and comparative data (for example, reference numeral 101010 in FIG. 1) provided from the bit generator 25. As illustrated in FIG. 1, the first logic device 22 may include, for example, an XOR gate, but the inventive concept is not limited thereto. In some embodiments of the inventive concept, the first logic device 22 may include other devices in addition to the XOR gate. For example, the first logic device 22 may include an AND gate, an OR gate, an NAND gate and the like, and may also include a logic circuit formed of a combination of the devices.

In addition, the second modulator 23 may include a second logic device 24 performing a logic operation between the first data DATA1 provided thereto and comparative data (for example, reference numeral 011010 in FIG. 1) provided from the bit generator 25.

The bit generator 25 generates comparative data, and also provides the comparative data to the first and second modulators 21 and 23. The comparative data provided by bit generator 25 to the first modulator 21 may be, for example, a data pattern 101010 having a maximum toggle rate, as illustrated in FIG. 1. Meanwhile, the comparative data provided by bit generator 25 to the second modulator 23 may be different from the comparative data provided to the first modulator 21 and may be, for example, data pattern 011010 as illustrated in FIG. 1. It should however be understood that the inventive concepts are not limited to respective comparative data with data patterns 101010 and 011010, and that the bit generator 25 may generate data patterns capable of statistically decreasing the toggle rate of the first data DATA1 according to a pattern of the first data DATA1, and may correspondingly provide such data patterns to the first and second modulators 21 and 23.

In an embodiment of the inventive concept, the second logic device 24 may include an XOR or XNOR gate, but the inventive concept is not limited thereto. For example, the second logic device 24 may include an AND gate, an OR gate, an NAND gate and the like, and may also include a logic circuit formed of a combination of the devices.

The second logic device 24 generates third data DATA3 that is a result of a logical operation between the first DATA1 and the comparative data provided by bit generator 25. The third data DATA3 has a toggle rate that is different from that of second data DATA2 which is generated by first logic device 22 as a result of a logical operation between the first data DATA1 and the comparative data provided by bit generator 25.

Among data transmission circuits, since circuits that simply perform the migration of data without performing data processing (data operation) may be present, it may be necessary to convert the toggle rate of data in order to reduce power consumption of the circuit in some cases.

In other words, when electrically transmitting data, processes in which a logic value of the data is changed typically occur, and consumption of power during data toggling may be generated. Thus, in order to configure a low power data transmission circuit, it may be desirable and necessary to reduce a toggle count (the number of toggling operations) of the data transmitted.

The semiconductor device 1 according to an embodiment of the inventive concept as shown in FIG. 1 monitors the toggle count and the toggle rate of the first data DATA1, and converts and outputs data having a different toggle rate in different manners depending on the toggle rate of the first data DATA1.

The first data DATA1 as input to the toggle rate converter 20 as shown in FIG. 1 has a logic value of 101101. The toggle rate converter 20 may be set in the conversion mode by the controller 10.

When the conversion mode is set in a first mode, the first modulator 21 converts the first data DATA1 into the second data DATA2 having a second toggle rate different from the toggle rate of the first data DATA1. Meanwhile, when the conversion mode is set in a second mode, the second modulator 23 converts the first data DATA1 into third data DATA3 having a third toggle rate different from the toggle rate of the first data DATA1.

FIG. 1 exemplifies a case in which the conversion mode is set to a first mode, and the toggle rate of the first data DATA1 is converted into the second data DATA2 by the first modulator 21. The first modulator 21 allows the provided first data DATA1 (101101) and the comparative data 101010 to pass the first logic device 22 to thereby perform the logic operation, and consequently outputs the second data DATA2 (000111) having the converted toggle rate.

In some embodiments of the inventive concept, a value of the comparative data (for example, 101010 in FIG. 1) may be set to be changed every bit of data in order that the converted second data DATA2 has a low toggle rate. However, the inventive concept is not limited thereto. For example, optional data having a bit length the same as that of the first data DATA1 may pass the first logic device 22, such that the second data DATA2 may be generated.

As illustrated in FIG. 1, the first data DATA1 having a value of 101101 is toggled four times over a total of 6 bits and has a toggle rate of about 0.66. On the other hand, the second data DATA2, which is an output of the first modulator 21 has a value of 000111, and is toggled one time over a total of 6 bits and has a toggle rate of about 0.16.

In the case of transmitting data having a reduced toggle count and a reduced toggle rate as described above, effects of decreasing the consumption of power during a data transmission process may be obtained.

Although not illustrated in FIG. 1, when the conversion mode set by the controller 10 is the second mode, the second modulator 23 converts the toggle rate of the first data DATA1 and generates the third data DATA3.

FIG. 1A illustrates a block diagram of a configuration and an operation of the controller of FIG. 1.

Referring to FIG. 1 and FIG. 1A, the first data DATA1 is provided to the controller 10. Then, the monitor 11 measures a toggle count (4) and a bit length (6) of the first data DATA1 and calculates a toggle rate (0.66) by dividing the toggle count by the bit length.

The comparator 12 determines whether or not the toggle rate measured by the monitor 11 is identical to or higher than a predetermined reference value. The reference value to be compared to the measured toggle rate may be differently set depending on characteristics of transmitted data and a circuit.

The mode selector 13 selects the conversion mode according to the compared result of the comparator 12. That is, when the conversion mode is set by the mode selector 13 to the first mode, the first modulator 21 converts the first data DATA1 having a first toggle rate into the second data DATA2 having a second toggle rate. On the other hand, when the conversion mode is set to the second mode, the second modulator 23 converts the first data DATA1 having the first toggle rate into the third data DATA3 having the third toggle rate.

FIGS. 1 and 1A exemplify a case in which the calculated toggle rate is identical or greater than the reference value so that the conversion mode is set to the first mode, and a signal indicative of the selected first mode is transmitted to the toggle rate converter 20, so that the first modulator 21 performs the toggle rate conversion. In a case (not shown) in which the calculated toggle rate is not identical or greater than the reference value, the conversion mode is set to the second mode, and a signal indicative of the selected second mode is transmitted to the toggle rate converter 20, so that the second modulator 23 performs the toggle rate conversion

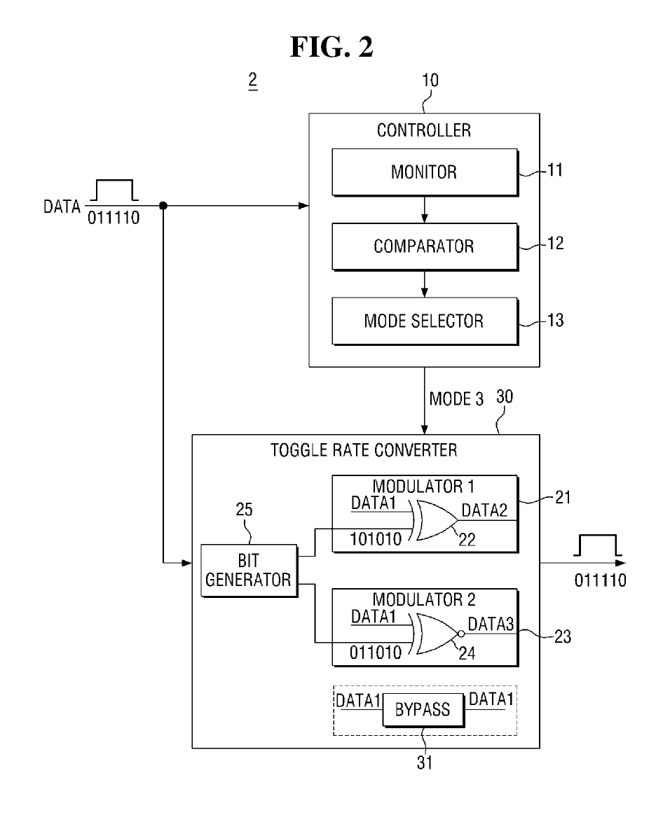

FIG. 2 illustrates a block diagram of a semiconductor device according to another embodiment of the inventive concept.

Referring to FIG. 2, semiconductor device 2 is different from the semiconductor device 1 described with respect to FIG. 1 in terms of the configuration of a toggle rate converter 30.

The toggle rate converter 30 may include the first modulator 21, the second modulator 23, and a bypass circuit 31. In the following, description of elements in FIG. 2 having the same configuration and functionality as corresponding elements in FIG. 1 may be omitted.

The toggle rate converter 30 shown in FIG. 2 may be set in a third mode different from the first and second modes, by the controller 10. In this case, in the third mode the toggle rate converter 30 does not convert the toggle rate of the first data DATA1 and allows the first data DATA1 to pass through the bypass circuit 31 without conversion so as to bypass the first and second modulators 21 and 23.

For example, when it is assumed that the first data DATA1 is data having a value of 011110 as illustrated in FIG. 2, the toggle rate of the first data DATA1 is calculated as 0.33. In the case that the toggle rate of the first data DATA1 is converted by allowing the first data DATA1 to pass through the first modulator 21, the converted data DATA2 would be indicated by 110100 and a toggle rate thereof would be calculated as 0.5. Thus, a toggle count and the toggle rate of such converted data DATA2 would be increased as compared to the toggle rate of first data DATA1, thereby leading to an increase in the consumption of power required in data transmission.

Thus, in the case that the first data DATA1 does not satisfy the predetermined reference value, a setting may be made such that the bypass of the first data DATA1 through bypass circuit 31 is enabled so that the toggle rate of the first data DATA1 is not converted, to thereby prevent an increase in power consumption.

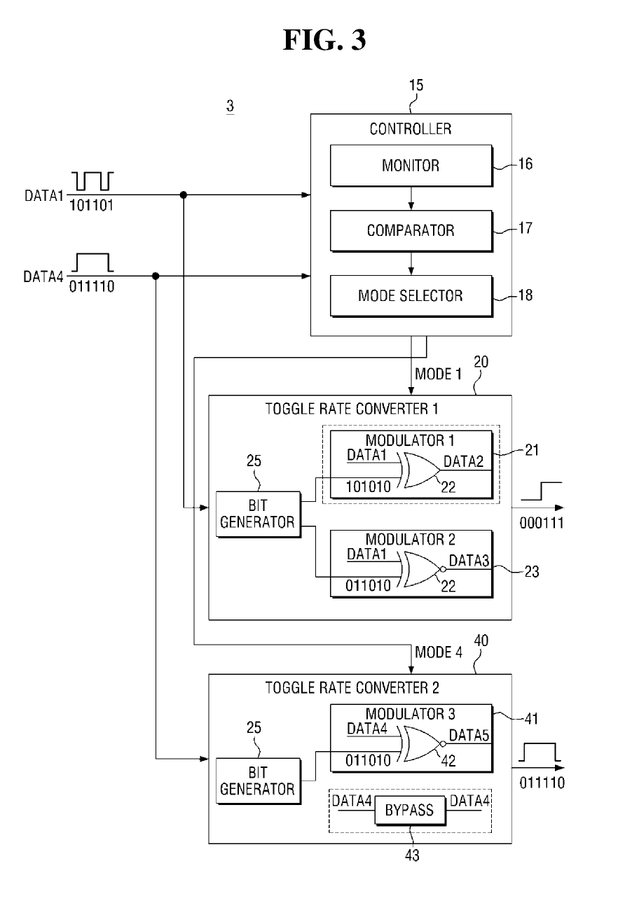

FIG. 3 illustrates a block diagram of a semiconductor device according to another embodiment of the inventive concept.

Referring to FIG. 3, semiconductor device 3 further includes a second toggle rate converter 40 that receives fourth data DATA4 and converts a toggle rate of the fourth data DATA4. In the following, description of elements in FIG. 3 having the same configuration and functionality as corresponding elements in FIG. 2 may be omitted.

Controller 15 receives the first data DATA1 and the fourth data DATA4 together, and includes a monitor 16 that monitors each of the first data DATA1 and the fourth data DATA4. In addition, the controller 15 includes a comparator 17 that compares a toggle rate of each of the first data DATA1 and the fourth data DATA4 with a reference value, and a mode selector 18 that sets conversion modes of the first and second toggle rate converters 20 and 40.

The second toggle rate converter 40 determines whether or not to convert the toggle rate of the fourth data DATA4 according to the mode provided thereto. That is, when the third mode is set, the fourth data DATA4 passes through a third modulator 41 including logic device 42, and is converted into fifth data DATA5 having a fifth toggle rate different from the fourth data DATA4. When a fourth mode is set, fourth data DATA4 passes through a bypass circuit 43 (bypassing the third modulator 41) so that the toggle rate of the fourth data DATA4 is not converted.

As illustrated in FIG. 3, the fourth data DATA4 may have, for example, a value of 011110. In this case, the conversion mode of the second toggle rate converter 40 is set to the fourth mode by the controller 15 as shown in FIG. 3, so that fourth data DATA4 is bypassed through bypass circuit 43 without conversion of the toggle rate.

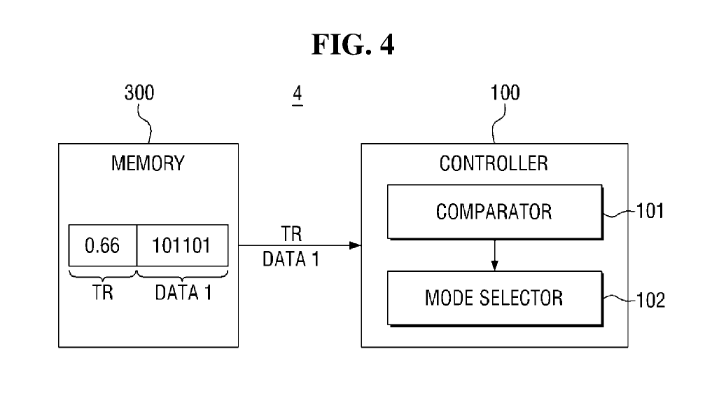

FIG. 4 illustrates a block diagram of a memory and a controller in a semiconductor device according to another embodiment of the inventive concept.

A semiconductor device 4 includes a controller 100 and a memory 300 that stores a toggle rate TR of the first data DATA1 therein. The toggle rate TR may be calculated by a separate operation unit rather than the controller 100, and may be previously stored in the memory 300.

In comparison with the controller 10 of FIG. 1, controller 100 does not include a monitor such as monitor 11 of FIG. 1. The reason for this is that when the memory 300 provides the first data DATA1 and the toggle rate TR thereof, it is unnecessary to separately calculate toggle rate TR of the first data DATA1 by the controller 100. Thus, a manufacturing cost of the controller 100 may be reduced.

In some embodiments of the inventive concept, the memory 300 may include a volatile memory such as DRAM, but is not limited thereto. For example, the memory 300 may be a non-volatile memory such as a NAND flash.

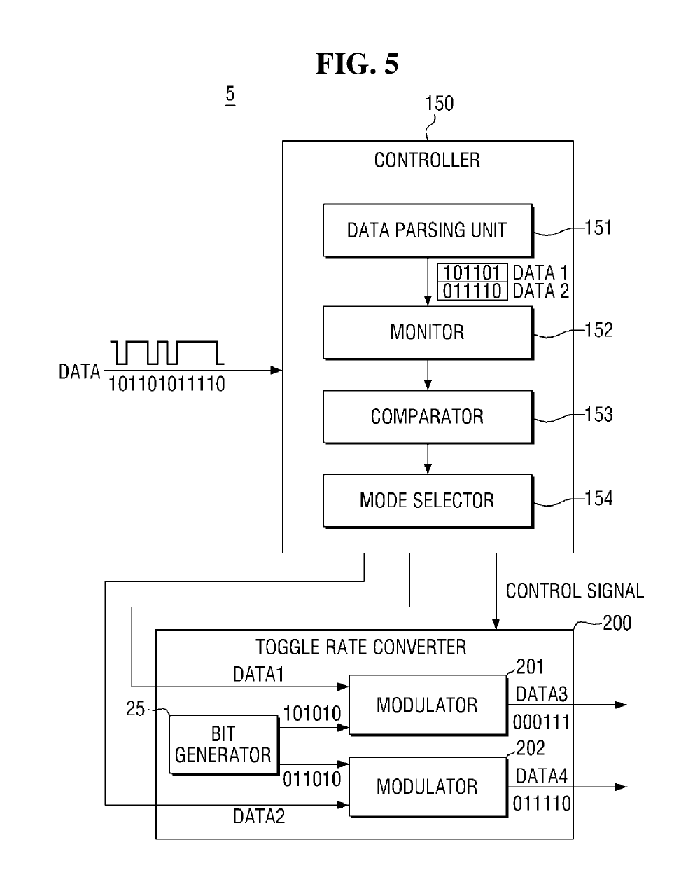

FIG. 5 illustrates a block diagram of a semiconductor device according to another embodiment of the inventive concept.

Referring to FIG. 5, in semiconductor device 5, configurations of a controller 150 and a toggle rate converter 200 are different from those of the foregoing embodiments.

The controller 150 includes a data parsing unit 151, a monitor 152, a comparator 153, and a mode selector 154. The toggle rate converter 200 includes bit generator 25, and first and second modulators 201 and 202. In the following, description of elements in FIG. 5 having the same configuration and functionality as corresponding elements in the previous figures may be omitted, and differences between the embodiments will be mainly described.

As shown in FIG. 5, a bit stream DATA is provided to the controller 150. The data parsing unit 151 parses the provided bit stream DATA into first data DATA1 and second data DATA2 respectively having a predetermined size.

The monitor 152 calculates toggle rates of the first data DATA1 and the second data DATA2, and the comparator 153 compares the toggle rates of the first data DATA1 and the second data DATA2 with a predetermined reference value.

When a first control signal is applied from the controller 150, the toggle rate converter 200 converts the first data DATA1 into third data DATA3. In addition, when a second control signal is applied from the controller 150, the toggle rate converter 200 converts the second data DATA2 into fourth data DATA4.

In this case, configurations of first and second modulators 201 and 202 may be different. That is, the first modulator 201 converts the first data DATA1 having a first toggle rate into the third data DATA3 having a third toggle rate different from the first toggle rate.

Meanwhile, the second modulator 202 may convert the second data DATA2 having a second toggle rate into the fourth data DATA4 having a fourth toggle rate different from the second toggle rate. Unlike this, the second modulator 202 may convert the second data DATA2 into the fourth data DATA4 having a fourth toggle rate identical to the second toggle rate, or in other words may allow the second data DATA2 to be bypassed without conversion of toggle rate.

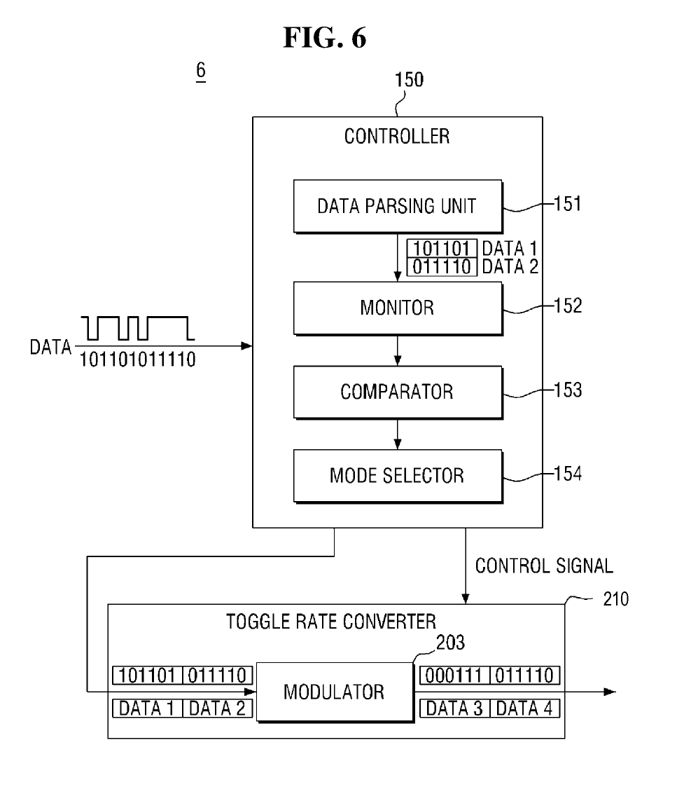

FIG. 6 illustrates a block diagram of a semiconductor device according to another embodiment of the inventive concept.

Referring to FIG. 6, a semiconductor device 6 includes the controller 150 and a toggle rate converter 210. The controller 150 includes a data parsing unit 151, a monitor 152, a comparator 153, and a mode selector 154. The toggle rate converter 210 includes a single modulator 203. In the following, description of elements in FIG. 6 having the same configuration and functionality as corresponding elements in the previous figures may be omitted, and differences between the embodiments will be mainly described.

The toggle rate converter 210 converts the first data DATA1 and the second data DATA2 parsed by the data parsing unit 151 of the controller 150 into third data DATA3 and fourth data DATA4.

The toggle rate converter 210 includes the single modulator 203. While the toggle rate converter 200 of FIG. 5 performs the toggle rate conversion using the two modulators 201 and 202, a single modulator 203 is used in this embodiment.

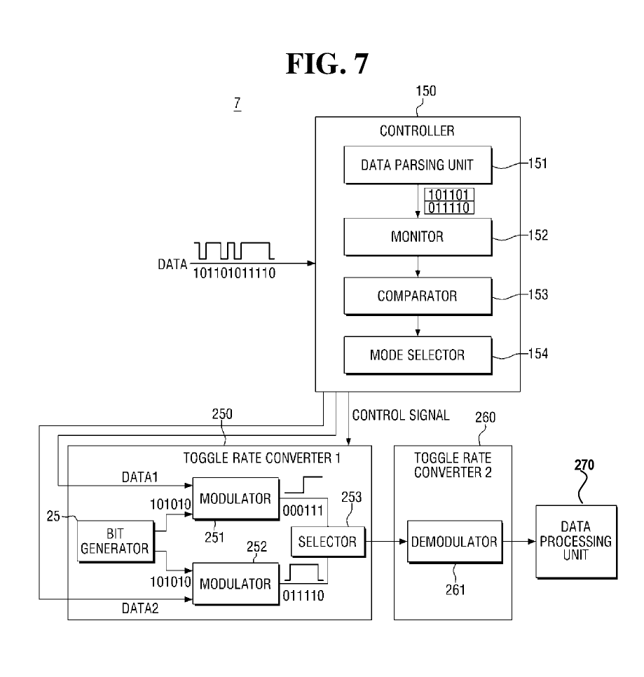

FIG. 7 illustrates a block diagram of a semiconductor device according to another embodiment of the inventive concept.

Referring to FIG. 7, a semiconductor device 7 include the controller 150, first and second toggle rate converters 250 and 260, and a data processing unit 270. In the following, description of elements in FIG. 7 having the same configuration and functionality as corresponding elements in the previous figures may be omitted, and differences between the embodiments will be mainly described.

The first toggle rate converter 250 receives first data DATA1 and second data DATA2 from the controller 150. The first toggle rate converter 250 includes first and second modulators 251 and 252, a selector 253 and bit generator 25.

The controller 150 includes a data parsing unit 151, a monitor 152, a comparator 153, and a mode selector 154. The data parsing unit 151 parses the provided bit stream DATA into the first data DATA1 and the second data DATA2 respectively having a predetermined amount of bits. The provided bit stream DATA may be image data for example, but the inventive concept is not limited thereto. The bit stream DATA may be sound data including audio data and voice data.

The selector 253 selects one of third data DATA3 and fourth data DATA4, toggle rates of which have been converted respectively by the first and second modulators 251 and 252, and provides the selected data to the second toggle rate converter 260. In this case, selection of third data DATA3 and fourth data DATA4 by selector 253 may be varied depending on a predetermined setting.

The second toggle rate converter 260 includes a demodulator 261. The demodulator 261 receives the selected one of the third data DATA3 and fourth data DATA4 from the first toggle rate converter 250. In an embodiment of the inventive concept, demodulator 261 may convert the selected one of the third data DATA3 and the fourth data DATA4 into the first data DATA1 again.

The data processing unit 270 receives the converted first data DATA1 from the second toggle rate converter 260, and performs data processing. In some embodiments of the inventive concept, the first data DATA1 may include image data and the data processing unit 270 may perform image processing. However, the inventive concept is not limited thereto, and in the case that the first data DATA1 includes for example audio data or voice data, the data processing unit 270 may perform sound processing.

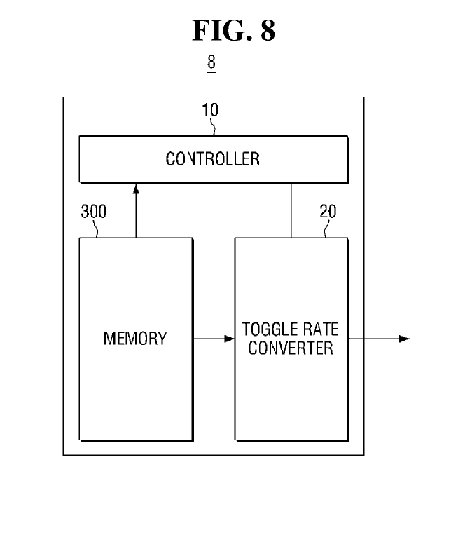

FIG. 8 illustrates a block diagram of a semiconductor device according to another embodiment of the inventive concept.

Referring to FIG. 8, a semiconductor device 8 includes a controller 10, a memory 300, and a toggle rate converter 20, and serves as a transmitter transmitting data, on which a toggle rate conversion has been performed, to an external device.

The toggle rate converter 20 may receive data from the memory 300 and perform the toggle rate conversion on the data, and may subsequently transmit the data to an external device.

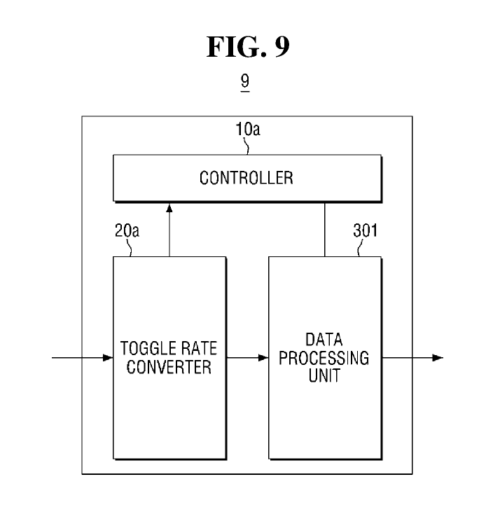

FIG. 9 illustrates a block diagram of a semiconductor device according to another embodiment of the inventive concept.

Referring to FIG. 9, a semiconductor device 9 includes a controller 10a, a toggle rate converter 20a, and a data processing unit 301. The controller 10a monitors data received from the outside and sets a conversion mode, and the toggle rate converter 20a converts the data into original data according to the set conversion mode.

The data processing unit 301 performs data processing on the original data subsequent to the toggle rate conversion. In some exemplary embodiments of the inventive concept, the data processing unit 301 performs image processing, but the inventive concept is not limited thereto.

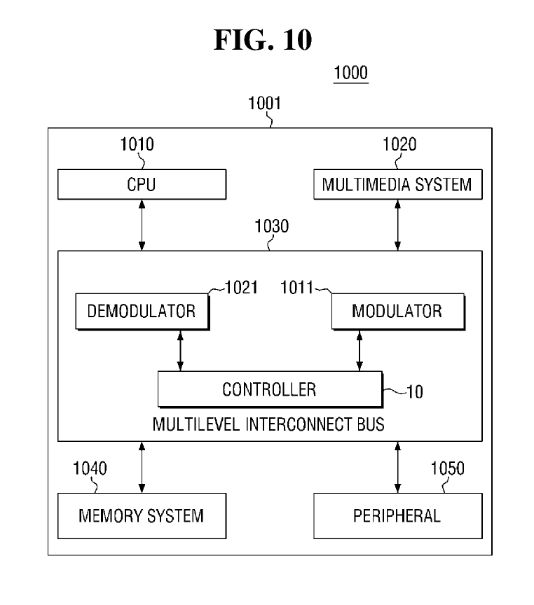

FIG. 10 illustrates a block diagram of a semiconductor device according to another embodiment of the inventive concept.

Referring to FIG. 10, a semiconductor device 1000 includes an application processor 1001.

The application processor 1001 includes a central processing unit (CPU) 1010, a multimedia system 1020, a bus 1030, a memory system 1040, and a peripheral circuit 1050.

The central processing unit (CPU) 1010 may perform processing required in driving the semiconductor device 1000. In some embodiments of the inventive concept, the central processing unit (CPU) 1010 may be configured as a multi-core environment including a plurality of cores.

The multimedia system 1020 may be used to perform various multimedia functions in semiconductor device 1000, which may be a System on Chip (SOC) system. The multimedia system 1020 may include a 3D engine module, a video codec, a display system, a camera system, a post-processor, and the like. The multimedia system 1020 may be a generator that generates multimedia data, such as image data for example.

The bus 1030 may be used to communicate data among the central processing unit (CPU) 1010, the multimedia system 1020, the memory system 1040, and the peripheral circuit 1050. In some embodiments of the inventive concept, the bus 1030 may have a multilayer structure. The bus 1030 may be, for example, a multi-layer Advanced High-performance Bus (AHB) or a multi-layer Advanced extensible Interface (AXI), but the inventive concept is not limited thereto.

The bus 1030 may include the controller 10, a modulator 1011 and a demodulator 1021.

The controller 10 may receive data and calculate a toggle rate thereof and may control toggle rate conversions of the modulator 1011 and the demodulator 1021.

The modulator 1011 may perform the toggle rate conversion on data received from the multimedia system 1020. The modulator 1011 may include the semiconductor devices according to the embodiments of the inventive concept as described above. The modulator 1011 may correspond to the toggle rate converter 20 of FIG. 1.

The demodulator 1021 may convert the data converted by the modulator 1011 into original data and may transmit the original data to the central processing unit (CPU) 1010. The demodulator 1021 may include the semiconductor devices according to the embodiments of the inventive concept as described above. The demodulator 1021 may correspond to the toggle rate converter 20 of FIG. 8.

The memory system 1040 may provide an environment required for the application processor 1001 to be connected to an external memory (for example, a DRAM) and to perform a high speed operation. In some embodiments of the inventive concept, the memory system 1040 may include a separate controller (for example, a DRAM controller) for controlling an external memory (for example, a DRAM).

The peripheral circuit 1050 may provide an environment required for the semiconductor device 1000 to be smoothly connected to an external device (for example, a main board). Accordingly, the peripheral circuit 1050 may include various interfaces allowing an external device connected to the semiconductor device 1000 to be compatible with the semiconductor device 1000.

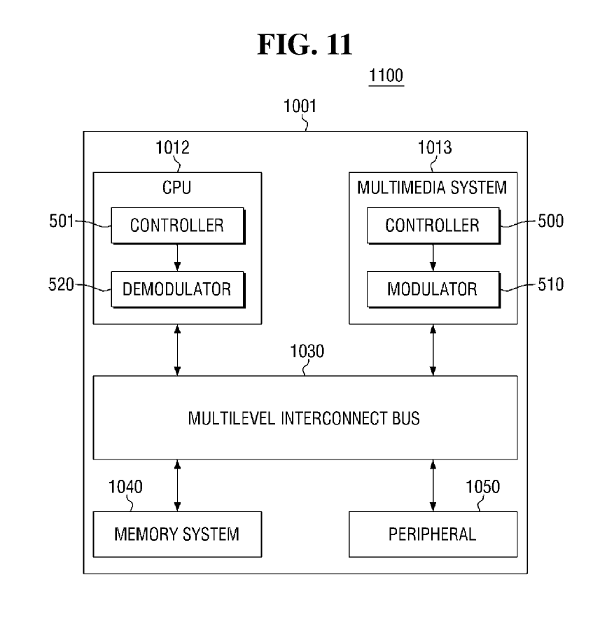

FIG. 11 illustrates a block diagram of a semiconductor device according to another embodiment of the inventive concept.

Referring to FIG. 11, a semiconductor device 1100 includes an application processor 1001. The application processor 1001 includes a CPU 1012, a multimedia system 1013, and a bus 1031 having forms different from those of the semiconductor device 1000 of FIG. 10.

That is, instead of the bus 1031 including the controller 10a of FIG. 9, the multimedia system 1013 includes a controller 500 that controls a modulator 510. In addition, the CPU 1012 includes a controller 501 that controls a demodulator 520.

The controllers, the modulator, and the demodulator 500, 501, 510 and 520 may include the semiconductor devices according to the exemplary embodiments of the inventive concept as described above. That is, the controllers 500 and 501 may correspond to the controller 10 of FIG. 1, and the modulator and the demodulator 510 and 520 may correspond to the toggle rate converter 20 of FIG. 1.

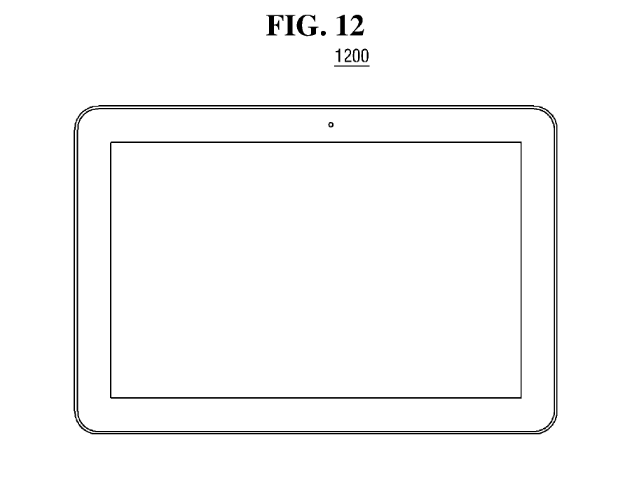

FIGS. 12 through 14 illustrate semiconductor systems to which the semiconductor devices according to embodiments of the inventive concept may be applied.

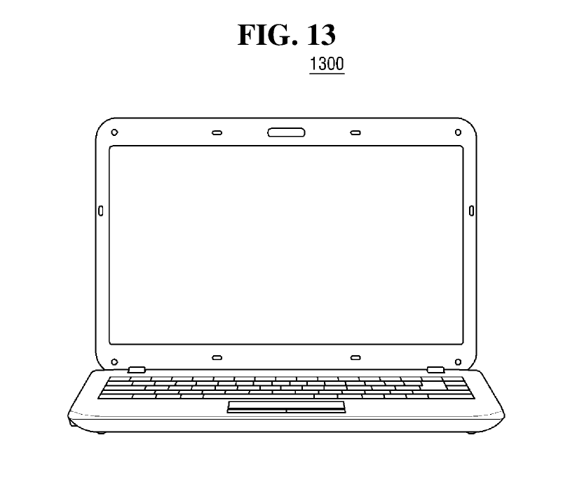

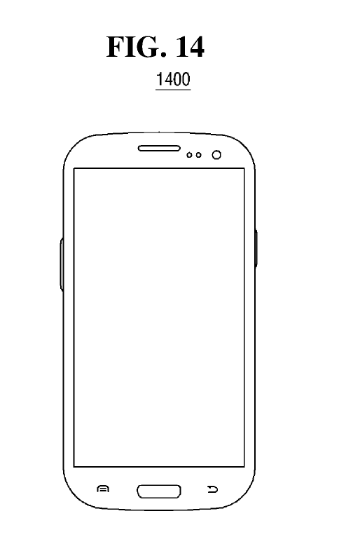

FIG. 12 illustrates a tablet PC 1200, FIG. 13 illustrates a laptop computer 1300, and FIG. 14 illustrates a smartphone 1400. At least one of the semiconductor devices according to the embodiments of the inventive concept may be used in the tablet PC 1200, the laptop computer 1300, the smartphone 1400 and the like.

In addition, it may be apparent to a person having ordinary skill in the art that the semiconductor devices according to some embodiments of the inventive concept may be applied to other semiconductor systems (not shown).

That is, in the above description, only the tablet PC 1200, the laptop computer 1300, and the smartphone 1400 are exemplified as the semiconductor systems according to the embodiments. However, examples of the semiconductor systems according to the exemplary embodiments are not limited thereto.

In some embodiments of the inventive concept, the semiconductor systems may be implemented as computers, Ultra Mobile PCs (UMPCs), workstations, net-book computers, personal digital assistants (PDAs), portable computers, wireless phones, mobile phones, e-books, portable multimedia players (PMPs), portable game consoles, navigation devices, black boxes, digital cameras, 3-dimensional televisions, digital audio recorders, digital audio players, digital picture recorders, digital picture players, digital video recorders, digital video players and the like.

While exemplary embodiments have been shown and described above, it will be apparent to those skilled in the art that modifications and variations could be made without departing from the spirit and scope of the inventive concept as defined by the appended claims. It is therefore desired that the embodiments be considered in all respects as illustrative and not restrictive, reference being made to the appended claims rather than the foregoing description to indicate the scope of the embodiments.

What is claimed is:

1. A semiconductor device comprising:
a controller configured to monitor a first toggle rate of first data and determine a conversion mode for the first data; and
a first toggle rate converter configured to convert the first data into second data having a second toggle rate different from the first toggle rate when the conversion mode is a first mode, and convert the first data into third data having a third toggle rate different from the first and second toggle rates when the conversion mode is a second mode different from the first mode.

2. The semiconductor device of claim 1, wherein the first toggle rate converter is further configured to pass the first data without conversion of the first toggle rate when the conversion mode is a third mode different from the first mode and the second mode.

3. The semiconductor device of claim 2, wherein the first toggle rate converter is configured to provide the second data responsive to an XOR or XNOR operation between the first data and first comparative data.

4. The semiconductor device of claim 3, wherein the first comparative data comprises a data pattern having maximum toggle rate.

5. The semiconductor device of claim 3, wherein the first toggle rate converter is configured to provide the third data responsive to an XOR or XNOR operation between the first data and second comparative data different from the first comparative data.

6. The semiconductor device of claim 1, wherein the controller comprises:
a monitor configured to monitor the first toggle rate;
a comparator configured to compare the first toggle rate and a reference value and determine whether or not the first toggle rate is identical to or higher than the reference value; and
a mode selector configured to select the conversion mode according to a result of comparator.

7. The semiconductor device of claim 1, wherein the controller is further configured to monitor fourth data having a fourth toggle rate and determine a conversion mode for the fourth data, and the semiconductor device further comprising:
a second toggle rate converter configured to convert the fourth data into fifth data having a fifth toggle rate different from the fourth toggle rate when the conversion mode is a third mode, and to pass the fourth data without conversion of the fourth toggle rate when the conversion mode is a fourth mode.

8. The semiconductor device of claim 1, further comprising:
a memory configured to store the first toggle rate therein,
wherein the controller is further configured to receive the first toggle rate stored in the memory and determine the conversion mode for the first data.

9. The semiconductor device of claim 1, wherein the first toggle rate comprises a toggle count of the first data divided by a bit length of the first data.

10. The semiconductor device of 1, wherein the second toggle rate and the third toggle rate are lower than the first toggle rate.

11. A semiconductor device comprising:
a controller configured to receive a bit stream, parse the bit stream into first data and second data respectively having a predetermined bit length, output a first control signal when a first toggle rate of the first data is equal to or higher than a reference value and output a second control signal when a second toggle rate of the second data is equal to or higher than the reference value; and
a first toggle rate converter configured to receive the bit stream, convert the first data into third data having a third toggle rate when the first control signal is applied thereto, and convert the second data into fourth data having a fourth toggle rate when the second control signal is applied thereto.

12. The semiconductor device of claim 11, wherein the first toggle rate and the third toggle rate are different from each other, and the second toggle rate and the fourth toggle rate are identical to each other.

13. The semiconductor device of claim 11, wherein the first toggle rate and the third toggle rate are different from each other, and the second toggle rate and the fourth toggle rate are different from each other.

14. The semiconductor device of claim 11, further comprising:
a second toggle rate converter and a processing unit,
wherein the bit stream includes a bit stream of image data,
wherein the second toggle rate converter configured to receive one of the third data and the fourth data from the first toggle rate converter and convert the one of the third data and the fourth data into the first data, and
wherein the processing unit configured to perform image processing using the first data.

15. A semiconductor device comprising:
a generator configured to generate first data having a first toggle rate;
a controller configured to monitor the first toggle rate and determine a conversion mode for the first data;
a modulator configured to convert the first data into second data having a second toggle rate when the conversion mode is a first mode, and convert the first data into third data having a third toggle rate when the conversion mode is a second mode different from the first mode;
a demodulator configured to receive one of the second data and the third data and convert the one of the second data and the third data into the first data according to the conversion mode; and
a processing unit configured to perform processing using the first data.

16. The semiconductor device of claim 15, wherein the generator comprises a multimedia system configured to generate image data as the first data, and
the processing unit comprises a central processing unit (CPU) configured to perform processing on the image data.

17. The semiconductor device of claim 15, wherein the first toggle rate and the third toggle rate are different from each other, and the second toggle rate and the fourth toggle rate are identical to each other.

18. The semiconductor device of claim 15, wherein the first toggle rate and the third toggle rate are different from each other, and the second toggle rate and the fourth toggle rate are different from each other.

19. The semiconductor device of claim 15, wherein the controller comprises a first controller and a second controller, and the first controller is disposed within the generator and the second controller is disposed within the processing unit.

20. The semiconductor device of 15, wherein the second toggle rate and the third toggle rate are lower than the first toggle rate.
